(19) United States
(12) Patent Application Publication
(10) Pub. No.: US 2021/0172823 A1
(43) Pub. Date: Jun. 10, 2021

(54) SELF-POWERED WATER LEAKAGE DETECTOR

(71) Applicant: DISCO CORPORATION, Tokyo (JP)

(72) Inventor: Kazuma SEKIYA, Tokyo (JP)

(21) Appl. No.: 17/110,464

(22) Filed: Dec. 3, 2020

(30) Foreign Application Priority Data
Dec. 10, 2019 (JP) 2019-222700

(51) Int. Cl. G01M 3/16; G08B 21/20

(52) U.S. Cl. CPC G01M 3/16; G08B 21/20

(57) ABSTRACT

A self-powered water leakage detector includes a water cell having a positive electrode and a negative electrode and a transmitter for transmitting a reporting signal by using electric power generated by the water cell that is brought into contact with water that has leaked. The water cell and the transmitter are fixedly housed in a case, and the case is adapted to be placed in an installation site where a water leakage is to be detected. When the case is placed in the installation site, the positive electrode and the negative electrode have respective lower ends disposed in a position that is equal to or lower than a level of the water leakage to be detected.

### BACKGROUND OF THE INVENTION

### Field of the Invention

The present invention relates to a self-powered water leakage detector.

### Description of the Related Art

Various water leakage detectors are manufactured for detecting water leakage in apparatuses and workshops where liquids such as water are used (see, for example, Japanese Patent No. 4218020). A band-shaped water leakage detector that has been used heretofore operates by supplying electric power to two electrically conductive bands, detecting a short circuit made between the electrically conductive bands by a water leakage to thereby determine the water leakage, and transmitting a signal reporting on the water leakage.

### SUMMARY OF THE INVENTION

The band-shaped water leakage detector referred to above needs to supply the electrically conductive bands with electric power at all times and also requires electric power for generating reporting signals. Therefore, the power supply of the band-shaped water leakage detector tends to limit sites where the band-shaped water leakage detector can be installed. In a case where a battery is used as the power supply, the band-shaped water leakage detector may possibly be unable to detect a water leakage in case of need due to a deterioration of the battery. Consequently, the existing water leakage detector runs the risk of failing to detect a water leakage.

It is therefore an object of the present invention to provide a self-powered water leakage detector that restrains itself from becoming unable to detect a water leakage.

In accordance with an aspect of the present invention, there is provided a self-powered water leakage detector including a water cell having a positive electrode and a negative electrode and a transmitter for transmitting a reporting signal by using electric power generated by the water cell that is brought into contact with water that has leaked.

Preferably, the water cell and the transmitter are fixedly housed in a case, and the case is adapted to be placed in an installation site where a water leakage is to be detected. Preferably, when the case is placed in the installation site, the positive electrode and the negative electrode have respective lower ends disposed in a position that is equal to or lower than a level of the water leakage to be detected.

Preferably, the reporting signal transmitted by the transmitter is established uniquely to the transmitter. Preferably, the self-powered water leakage detector further includes a light emitting diode (LED) to be turned on using the electric power generated by the water cell.

Preferably, the self-powered water leakage detector further includes a water leakage detecting band having a pair of electrically conductive wires insulated from each other, and a sensor for detecting a short circuit caused between the electrically conductive wires by a water leakage. The transmitter transmits the reporting signal indicating the water leakage when the short circuit caused between the electrically conductive wires is detected by the sensor.

The self-powered water leakage detector according to present invention is advantageous in that it restrains itself from becoming unable to detect a water leakage.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view illustrating a configuration example of a self-powered water leakage detector according to a first embodiment of the present invention;

FIG. 2 is a plan view of the self-powered water leakage detector illustrated in FIG. 1;

FIG. 3 is a block diagram illustrating a configuration of the self-powered water leakage detector illustrated in FIG. 1;

FIG. 4 is a side elevational view of the self-powered water leakage detector illustrated in FIG. 1;

FIG. 5 is a diagram illustrating an example of a reporting signal transmitted from a transmitter of the self-powered water leakage detector illustrated in FIG. 1;

FIG. 6 is a perspective view illustrating a configuration example of a self-powered water leakage detector according to a second embodiment of the present invention;

FIG. 7 is a block diagram illustrating a configuration of the self-powered water leakage detector illustrated in FIG. 6;

FIG. 8 is a side elevational view of the self-powered water leakage detector illustrated in FIG. 6;

FIG. 9 is a plan view illustrating a configuration example of a self-powered water leakage detector according to a third embodiment of the present invention;

FIG. 10 is a block diagram illustrating a configuration of the self-powered water leakage detector illustrated in FIG. 9; and

FIG. 11 is a side elevational view of the self-powered water leakage detector illustrated in FIG. 9.

### DETAILED DESCRIPTION OF THE PREFERRED EMBODIMENTS

Preferred embodiments of the present invention will hereinafter be described in detail with reference to the drawings. The present invention is not limited to the details of the embodiments described below. The components described below cover those which could easily be envisaged by those skilled in the art and those which are essentially identical to those described above. Further, the arrangements described below can be used in appropriate combinations. Various omissions, replacements, or changes of the arrangements may be made without departing from the scope of the present invention.

### First Embodiment

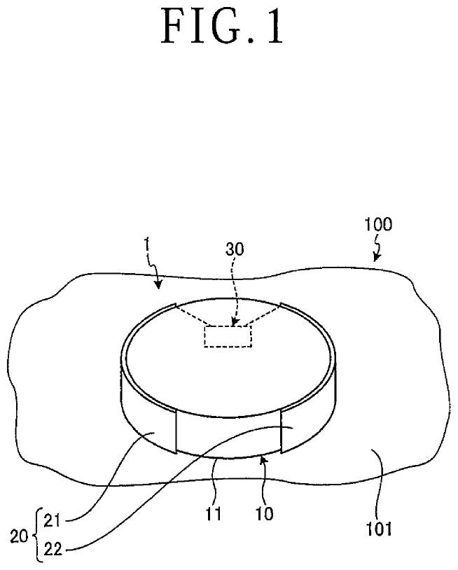

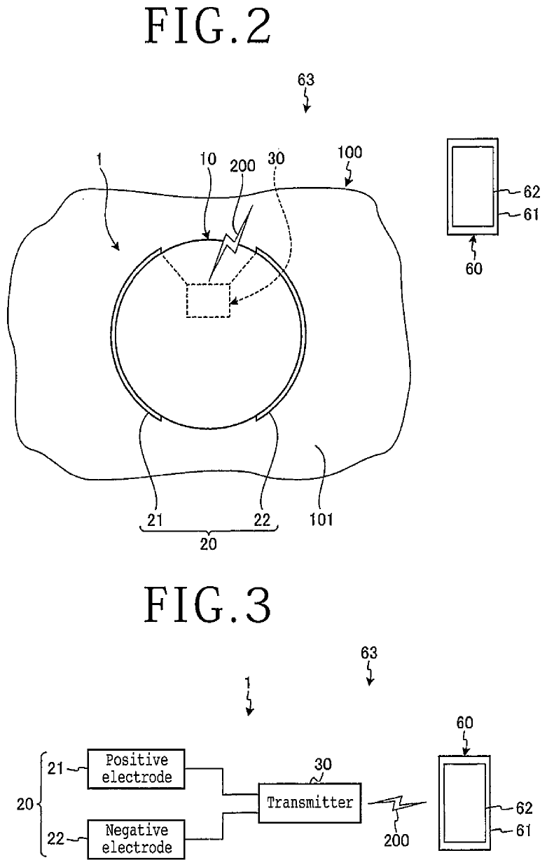

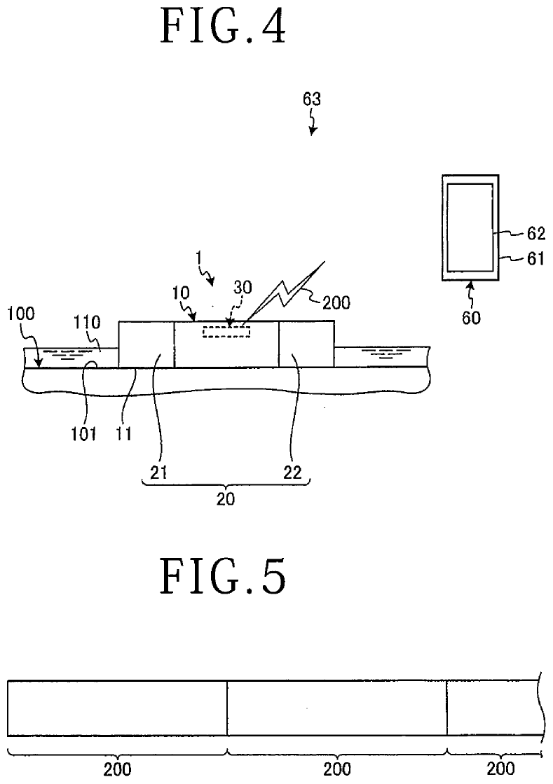

A self-powered water leakage detector according to a first embodiment of the present invention will hereinafter be described with reference to FIGS. 1 through 5. FIG. 1 illustrates in perspective a configuration example of the self-powered water leakage detector according to the first embodiment. FIG. 2 illustrates in plan the self-powered water leakage detector illustrated in FIG. 1. FIG. 3 illustrates in block form a configuration of the self-powered water leakage detector illustrated in FIG. 1. FIG. 4 illustrates in side elevation the self-powered water leakage detector illustrated in FIG. 1. FIG. 5 illustrates an example of a reporting signal transmitted from a transmitter of the self-powered water leakage detector illustrated in FIG. 1.

A self-powered water leakage detector (hereinafter simply referred to as “water leakage detector”), denoted by 1 in FIG. 1, according to the first embodiment is installed at a given installation site 100 in a building for detecting a water leakage at the installation site 100 by detecting whether or not water is present at the installation site 100. The installation site 100 refers to a site where it is not desirable for water to collect in any of various buildings, i.e., where a water leakage is to be detected. The water leakage detector 1 is installed on a floor 101 of the installation site 100, for example.

As illustrated in FIGS. 1 and 2, the water leakage detector 1 includes a case 10, a water cell 20, and a transmitter 30. The case 10, which provides an outer shell of the water leakage detector 1, is of a disk shape according to the present embodiment. According to the present invention, however, the case 10 is not limited to a disk shape. The case 10 has a circular bottom surface 11 placed on the floor 101 of the installation site 100.

As illustrated in FIGS. 1 through 4, the water cell or water battery 20 has a positive electrode 21 and a negative electrode 22 that are disposed on an outer surface of the case 10 and spaced apart from each other. The positive electrode 21 and the negative electrode 22 are secured to the outer surface of the case 10. The water cell 20 operates as follows: When the positive electrode 21 and the negative electrode 22 contact water 110 (see FIG. 4) that has leaked into the installation site 100, they dissolve ions into the water 110 and the dissolved ions move between the positive electrode 21 and the negative electrode 22, generating electromotive forces between the positive electrode 21 and the negative electrode 22, i.e., generating electric power. When electromotive forces are generated between the positive electrode 21 and the negative electrode 22, the water cell 20 generates electric power, thereby detecting the water 110 that has leaked into the installation site 100. Both the positive electrode 21 and the negative electrode 22 are electrically connected to the transmitter 30 and output the generated electric power to the transmitter 30.

When the case 10 is placed on the floor 101 of the installation site 100, the positive electrode 21 and the negative electrode 22 have respective lower ends positioned at such a height from the bottom surface 11 of the case 10 that is equal to or lower than a level of the water 110 to be detected that has leaked into the installation site 100. According to the first embodiment, the respective lower ends of the positive electrode 21 and the negative electrodes 22 are positioned at the same height as the bottom surface 11 of the case 10. According to the present invention, however, the respective lower ends of the positive electrode 21 and the negative electrodes 22 are not limited to the height illustrated in FIG. 4.

The transmitter 30 transmits a reporting signal 200 representing information to be reported as illustrated in FIG. 5, by using the electric power generated by the water cell 20 when it contacts the water 110 that has leaked into the installation site 100. According to the first embodiment, the transmitter 30 is housed in the case 10 and fixed to the case 10. According to the first embodiment, when the transmitter 30 is supplied with electric power from the water cell 20, the transmitter 30 repeatedly transmits the reporting signal 200 illustrated in FIG. 5, by using the electric power generated by the water cell 20 as a power supply. According to the first embodiment, the reporting signal 200 is established uniquely to the transmitter 30, i.e., the water leakage detector 1. In other words, different transmitters 30, i.e., different water leakage detectors 1, transmit different reporting signals 200. According to the first embodiment, the reporting signal 200 is a signal used also to distinguish the water leakage detector 1 from other water leakage detectors 1. According to the present invention, however, the reporting signal 200 is not limited to such use.

The transmitter 30 includes a sender for sending a reporting signal 200 when the water cell 20 generates electric power and supplies the electric power to the sender, and a controller for controlling the sender. When the controller establishes a reporting signal 200 and the water cell 20 supplies electric power to the sender, the sender repeatedly sends the established reporting signal 200, by using the electric power from the water cell 20 as a power supply. The controller controls operation of the sender. According to the first embodiment, the controller is constructed as a dedicated processing circuit, i.e., a piece of hardware, such as a single circuit, a composite circuit, a programmed processor, or parallel-programmed processors.

According to the first embodiment, the reporting signal 200 transmitted from the transmitter 30 is received by a terminal apparatus 60 illustrated in FIGS. 2, 3, and 4, for example. The terminal apparatus 60 may be a mobile terminal that can be carried by the user thereof, for example. According to the first embodiment, as illustrated in FIGS. 2 and 3, the terminal apparatus 60 is in the form of a tablet or a portable computer including a casing 61, a display unit 62, an input unit, a wireless communication unit, an arithmetic processing unit having a microprocessor such as a central processing unit (CPU), a storage unit having a memory such as a read only memory (ROM) or a random access memory (RAM), and an input/output interface unit. According to the present invention, however, the terminal apparatus 60 is not limited to a tablet or a portable computer, but may be any of electronic equipment insofar as it can be carried by the user.

The casing 61 houses therein at least the wireless communication unit, the arithmetic processing unit, the storage unit, and the input/output interface unit of the terminal apparatus 60. The arithmetic processing unit of the terminal apparatus 60 performs arithmetic processing operations according to computer programs stored in the storage unit and outputs a control signal for controlling the terminal apparatus 60 via the input/output interface unit to the units of the terminal apparatus 60.

The display unit 62 includes a liquid crystal display unit or the like. The display unit 62 displays characters, still images, moving images, symbols, and figures.

The input unit receives operation inputs from the user. According to the first embodiment, the input unit is in the form of a touch screen placed in covering relation to the display unit 62. The touch screen employs as its detecting system an electrostatic capacitance system, a resistance film system, a surface acoustic wave system, an ultrasonic system, an infrared system, an electromagnetic induction system, or a load detecting system. The wireless communication unit is connected so as to be able to receive the reporting signal 200 transmitted from the transmitter 30 of the water leakage detector 1.

When the terminal apparatus 60 receives the reporting signal 200, it displays information for distinguishing the water leakage detector 1 indicated by the reporting signal 200 on the display unit 62.

According to the first embodiment, a plurality of water leakage detectors 1 may be installed on the floors 101 of a plurality of installation sites 100 in a building, and the terminal apparatus 60 may receive reporting signals 200 transmitted from the transmitters 30 of the water leakage detectors 1. In this case, the terminal apparatus 60 displays a plan of the building to the display unit 62 and further displays the installation sites 100 on the plan of the building of the water leakage detectors 1 from which the reporting signals 200 have been received. The terminal apparatus 60 and the water leakage detectors 1 jointly make up a water leakage detecting system 63 for detecting a water leakage in the building as illustrated in FIGS. 2, 3, and 4. In FIGS. 2, 3, and 4, only one of the water leakage detectors 1 is illustrated and the other water leakage detectors 1 are omitted from illustration.

The water leakage detector 1 of the configuration described above is installed on the floor 101 of the installation site 100. When the positive electrode 21 and the negative electrode 22 contact water 110 that has leaked, the water cell 20 supplies electric power to the transmitter 30, thereby detecting the water 110 that has leaked. Upon detection of the water 110 that has leaked, the water leakage detector 1 supplies electric power from the water cell 20 to the transmitter 30, which transmits a reporting signal 200 to indicate to the terminal apparatus 60 that the water leakage detector 1 has detected the water 110 that has leaked.

With the water leakage detector 1 according to the first embodiment described above, when the water cell 20 contacts the water 110 that has leaked, the water cell 20 generates electric power by generating electromotive forces between the positive electrode 21 and the negative electrode 22, and the transmitter 30 transmits a reporting signal 200 by using the electric power generated by the water cell 20 as a power source. Therefore, the water leakage detector 1 can detect water that has leaked into the installation site 100 in the building without being supplied with electric power from a commercial power supply or a direct current (DC) power supply such as a battery. As a result, inasmuch as the water leakage detector 1 can detect water that has leaked into the installation site 100 in the building without being supplied with electric power from a commercial power supply or a DC power supply such as a battery, the water leakage detector 1 is advantageous in that it restrains itself from becoming unable to detect the water 110 that has leaked.

Further, since the water leakage detector 1 is able to detect water that has leaked into the installation site 100 in a building without being supplied with electric power from a commercial power supply or a DC power supply such as a battery, the water leakage detector 1 is free from limitations that would otherwise be imposed on the installation site 100 by the supply of electric power, the degree of freedom of the installation site 100 is very high, and the water leakage detector 1 does not run the risk of suffering from a battery deterioration and a battery energy loss.

As the water leakage detector 1 can establish a reporting signal 200 uniquely to the transmitter 30, i.e., the water leakage detector 1, the water leakage detector 1 can acquire information representing the position or the like of the installation site 100 where a water leakage has been detected by receiving the reporting signal 200 with the terminal apparatus 60. Further, even if many water leakage detectors 1 are installed in a building as they can be installed with ease, it is possible to recognize where a water leakage is occurring in the building.

### Second Embodiment

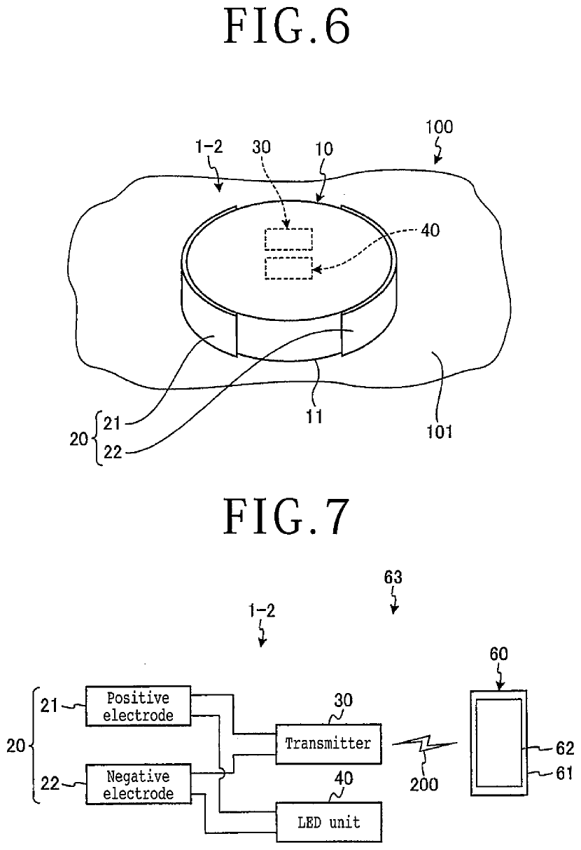

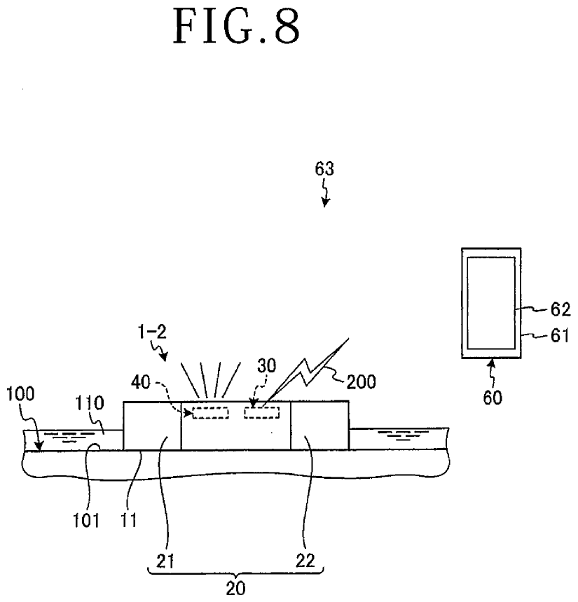

A self-powered water leakage detector according to a second embodiment of the present invention will hereinafter be described with reference to FIGS. 6 through 8. FIG. 6 illustrates in perspective a configuration example of the self-powered water leakage detector according to the second embodiment. FIG. 7 illustrates in block form a configuration of the self-powered water leakage detector illustrated in FIG. 6. FIG. 8 illustrates in side elevation the self-powered water leakage detector illustrated in FIG. 6. Those parts in FIGS. 6, 7, and 8 which are identical to those according to the first embodiment are denoted by identical reference characters, and their description will be omitted hereinbelow.

A self-powered water leakage detector (hereinafter simply referred to as “water leakage detector”), denoted by 1-2 in FIGS. 6 through 8, according to the second embodiment is similar to the water leakage detector 1 according to the first embodiment except that it includes an LED unit 40 as illustrated in FIGS. 6, 7, and 8 and the case 10 is made of a transparent or semitransparent material.

The LED unit 40 is housed in the case 10 and fixed to the case 10. The LED unit 40 includes at least one LED. The LED unit 40 is electrically connected to the positive electrode 21 and the negative electrode 22 of the water cell 20. When the LED unit 40 is supplied with electric power generated by the water cell 20, the LED unit 40 turns on the LED thereof by using the supplied electric power as a power supply.

The water leakage detector 1-2 of the configuration described above according to the second embodiment is installed on the floor 101 of the installation site 100. When the positive electrode 21 and the negative electrode 22 contact water 110 that has leaked, the water cell 20 supplies electric power to the transmitter 30, which transmits a reporting signal 200 to indicate to the terminal apparatus 60 that the water leakage detector 1-2 has detected the water 110 that has leaked, as with the first embodiment. Further, when the positive electrode 21 and the negative electrode 22 contact water 110 that has leaked, the water leakage detector 1-2 according to the second embodiment supplies electric power from the water cell 20 to the LED unit 40, turning on the LED thereof.

With the water leakage detector 1-2 according to the second embodiment described above, when the water cell 20 contacts the water 110 that has leaked, the water cell 20 generates electric power by generating electromotive forces between the positive electrode 21 and the negative electrode 22, and the transmitter 30 transmits a reporting signal 200 by using the electric power generated by the water cell 20 as a power source. Therefore, as with the first embodiment, the water leakage detector 1-2 can detect the water that has leaked without being supplied with electric power from a commercial power supply or a DC power supply such as a battery. As a result, the water leakage detector 1-2 is advantageous in that it restrains itself from becoming unable to detect the water 110 that has leaked.

Further, since the water leakage detector 1-2 according to the second embodiment includes the LED unit 40 that turns on the LED by using electric power generated by the water cell 20 when electromotive forces are generated between the positive electrode 21 and the negative electrode 22 upon contact with the water 110 that has leaked, the water leakage detector 1-2 is further advantageous in that it allows the user to find where a water leakage is occurring in the building even in the dark by viewing the LED unit 40 of the water leakage detector 1-2.

### Third Embodiment

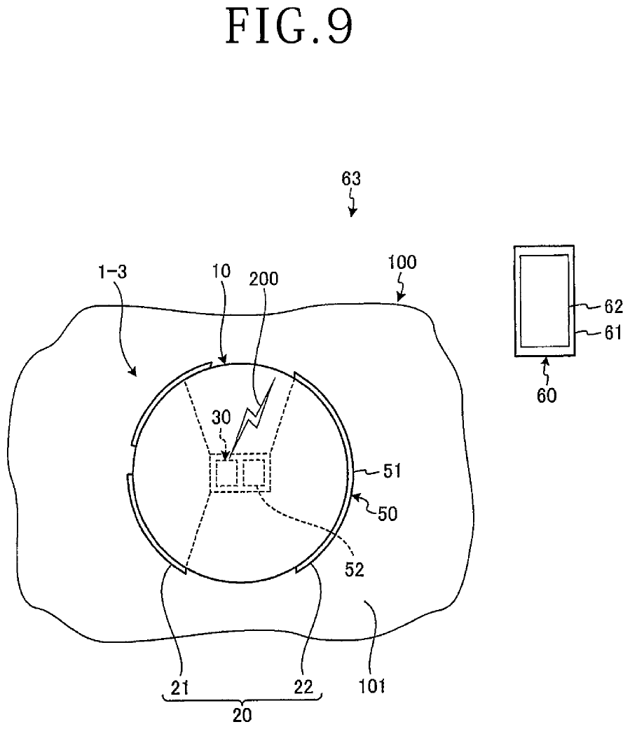

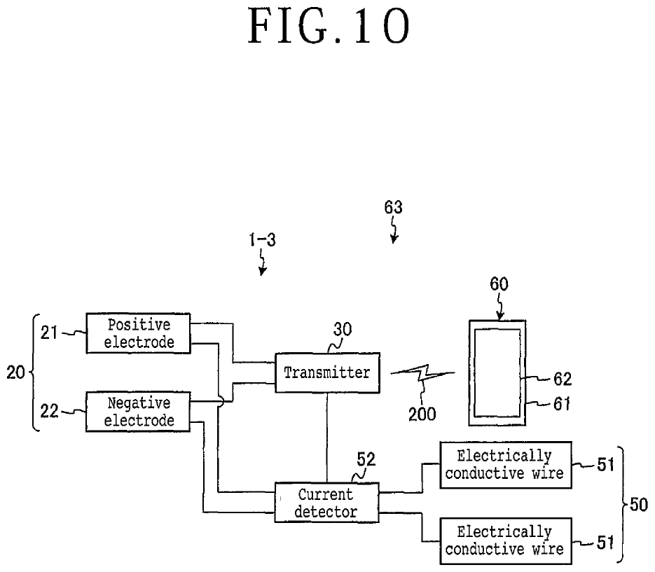

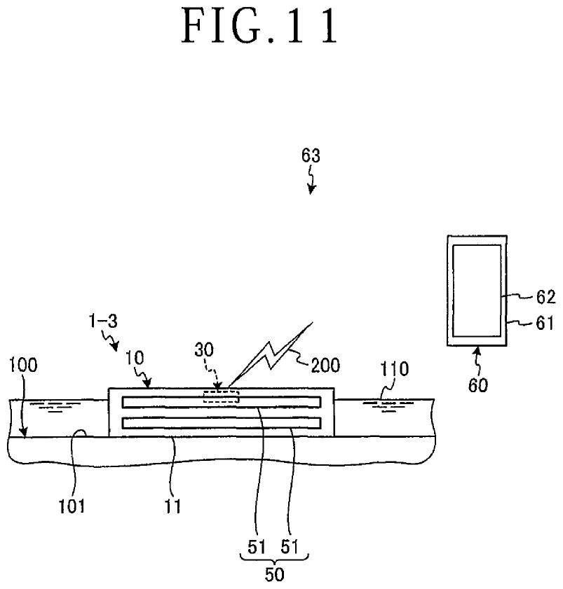

A self-powered water leakage detector according to a third embodiment of the present invention will hereinafter be described with reference to FIGS. 9 through 11. FIG. 9 illustrates in plan a configuration example of the self-powered water leakage detector according to the third embodiment. FIG. 10 illustrates in block form a configuration of the self-powered water leakage detector illustrated in FIG. 9. FIG. 11 illustrates in side elevation the self-powered water leakage detector illustrated in FIG. 9. Those parts in FIGS. 9, 10, and 11 which are identical to those according to the first embodiment are denoted by identical reference characters, and their description will be omitted hereinbelow.

A self-powered water leakage detector (hereinafter simply referred to as “water leakage detector”), denoted by 1-3 in FIGS. 9 through 11, according to the third embodiment is similar to the water leakage detector 1 according to the first embodiment except that it includes a water leakage detecting band 50 having a pair of electrically conductive wires 51 and a current detector 52 as a sensor, electric power generated by the water cell 20 is supplied to the current detector 52 and the electrically conductive wires 51, and when the current detector 52 detects a short circuit between the electrically conductive wires 51, the transmitter 30 transmits a reporting signal 200.

The electrically conductive wires 51 of the water leakage detecting band 50 are insulated from each other. According to the third embodiment, the electrically conductive wires 51 are disposed on an outer surface of the case 10 and spaced from each other in thicknesswise directions of the case 10. The electrically conductive wires 51 are supplied with electric power generated by the water cell 20. The electrically conductive wires 51 are electrically connected to the current detector 52. When each of the electrically conductive wires 51 contacts water 110 that has leaked into the installation site 100, a short circuit is caused between the electrically conductive wires 51 supplied with the electric power generated by the water cell 20.

The current detector 52 detects the short circuit between the electrically conductive wires 51 that is caused by the water 110 that has leaked. The current detector 52 operates by using the electric power generated by the water cell 20 as a power supply. When the current detector 52 detects the short circuit between the electrically conductive wires 51, it repeatedly transmits a signal indicating the short circuit between the electrically conductive wires 51 to the transmitter 30. According to the third embodiment, the current detector 52 is constructed as a dedicated processing circuit, i.e., a piece of hardware, such as a single circuit, a composite circuit, a programmed processor, or parallel-programmed processors.

According to the third embodiment, when the transmitter 30 receives the signal indicating the short circuit between the electrically conductive wires 51 from the current detector 52, the transmitter 30 repeatedly transmits the reporting signal 200 by using the electric power generated by the water cell 20 as a power supply. According to the third embodiment, unless the transmitter 30 receives the signal indicating the short circuit between the electrically conductive wires 51 from the current detector 52, the transmitter 30 does not transmit the reporting signal 200 even though it is supplied with the electric power from the water cell 20.

With the water leakage detector 1-3 of the above configuration according to the third embodiment, the water cell 20 generates electric power when the positive electrode 21 and the negative electrode 22 contact water 110 that has leaked into the installation site 100. Then, the water cell 20 supplies the generated electric power to the transmitter 30, the current detector 52, and the electrically conductive wires 51. When each of the electrically conductive wires 51 contacts the water 110 that has leaked into the installation site 100, a short circuit occurs between the electrically conductive wires 51, and the current detector 52 detects the short circuit between electrically conductive wires 51 and repeatedly transmits the signal described above to the transmitter 30, which repeatedly transmits a reporting signal 200.

The transmitter 30 transmits the reporting signal 200 by using the electric power generated by the water cell 20 upon contact with the water 110 that has leaked. Therefore, as with the first embodiment, the water leakage detector 1-3 according to the third embodiment can detect the water 110 that has leaked without being supplied with electric power from a commercial power supply or a DC power supply such as a battery. As a result, the water leakage detector 1-3 is advantageous in that it restrains itself from becoming unable to detect the water 110 that has leaked.

With the water leakage detector 1 according to the first embodiment, once the positive electrode 21 and the negative electrode 22 have been wet with water, a voltage tends to remain on the water cell 20 even if water droplets are wiped out, and the transmitter 30 tends to transmit a reporting signal 200. The water leakage detector 1-3 according to the third embodiment, however, includes, separately from the water cell 20, the water leakage detecting band 50 having the electrically conductive wires 51, and the current detector 52 for detecting a short circuit between the electrically conductive wires 51 of the water leakage detecting band 50. With the water leakage detector 1-3 according to the third embodiment, the transmitter 30 does not transmit a reporting signal 200 even though it is supplied with the electric power from the water cell 20 unless the transmitter 30 receives a signal indicating a short circuit between the electrically conductive wires 51 from the current detector 52.

As a result, as the water leakage detector 1-3 according to the third embodiment uses the water cell 20 as a power supply that generates electric power by using water 110 that has leaked, and transmits a reporting signal 200 only when the water leakage detecting band 50 detects a water leakage, so that the water leakage detector 1-3 can restrain the transmitter 30 from continuously transmitting a reporting signal 200 due to a remaining voltage on the water cell 20.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A self-powered water leakage detector comprising:
a water cell having a positive electrode and a negative electrode; and
a transmitter for transmitting a reporting signal by using electric power generated by the water cell that is brought into contact with water that has leaked.

2. The self-powered water leakage detector according to claim 1, further comprising:
a case, the water cell and the transmitter being fixedly housed in the case, wherein
the case is adapted to be placed in an installation site where a water leakage is to be detected.

3. The self-powered water leakage detector according to claim 2, wherein,
when the case is placed in the installation site, the positive electrode and the negative electrode have respective lower ends disposed in a position that is equal to or lower than a level of the water leakage to be detected.

4. The self-powered water leakage detector according to claim 1, wherein
the reporting signal transmitted by the transmitter is established uniquely to the transmitter.

5. The self-powered water leakage detector according to claim 1, further comprising:
a light emitting diode to be turned on using the electric power generated by the water cell.

6. The self-powered water leakage detector according to claim 1, further comprising:
a water leakage detecting band having a pair of electrically conductive wires insulated from each other; and
a sensor for detecting a short circuit caused between the electrically conductive wires by a water leakage, wherein
the transmitter transmits the reporting signal indicating the water leakage when the short circuit caused between the electrically conductive wires is detected by the sensor.
